(19) United States
(12) Patent Application Publication
(10) Pub. No.: US 2011/0101842 A1
(43) Pub. Date: May 5, 2011

(54) Distributed Element Light-Emitting-Diode (LED) Light Fixture

(76) Inventor: Anthony Valenzano, Archbald, PA (US)

(21) Appl. No.: 12/916,840

(22) Filed: Nov. 1, 2010

Related U.S. Application Data
(60) Provisional application No. 61/280,268, filed on Nov. 2, 2009.

(51) Int. Cl. H01J 61/52; H01J 5/00; H01K 1/30; H01J 1/62; H01J 9/24

(52) U.S. Cl. 313/46; 313/317; 313/116; 313/483; 445/23

(57) ABSTRACT

The invention is a distributed element LED light bulb 11 comprising an envelope 13 having an inside surface 15 and an outside surface 17. The light bulb 11 includes at least one mount 19 having a first conductive member 21 and a second conductive member 23. The mount 19 is for securing the envelope 13 in a fixture or a socket and for providing electrical current from the socket or fixture to the LED light bulb. A plurality of LEDs 25 are mounted on the inside surface 15 of the envelope 13 and disposed to emit light inwardly. One or more electrical elements 27 provide current to/from the plurality of LEDs 25.

### CROSS REFERENCE TO RELATED APPLICATIONS

This application claims priority to U.S. provisional application Ser. No. 61/280,268 filed on Nov. 2, 2009, and incorporates the same by reference as if set forth herein in its entirety.

### STATEMENT AS TO FEDERALLY SPONSORED RESEARCH

Not applicable.

### BACKGROUND OF INVENTION

a. Field of Invention

The invention relates generally to light bulbs that are lit with LEDs. Particularly, the invention relates to a distributed element LED light bulb having the LEDs mounted on the inside of the bulb affixed to the envelope.

b. Background of Invention

In general, an incandescent lamp comprising a filament as a light source has a high power consumption and a short life. In or to solve these problems it has been considered that LED lamps are used instead of a filament as a light source of an electric bulb. The LED elements of LED bulbs also generate heat during operation, and the bulb design must incorporate a means of dissipating the heat generated from the LED bulb. Present LED configurations mount heat transfer means at the base of the bulb towards the socket mount. Accordingly, the LED are outwardly faced and mounted on a heat sink.

Present LED light bulbs also lack the aesthetic characteristic of a traditional bulb. The individual LEDs are often viewable through the bulb, and the light of the LED bulb is often not dispersed well and not uniformly emitted.

c. Objects and Advantages

An objective of the current invention is to provide an LED light bulb that facilitates heat dissipation. Another object of the invention is to provide an LED light bulb that is more aesthetically pleasing then the present status of the art.

### SUMMARY OF INVENTION

The invention is a distributed element LED light bulb 11 comprising an envelope 13 having an inside surface 15 and an outside surface 17. The light bulb 11 includes at least one mount 19 having a first conductive member 21 and a second conductive member 23. The mount 19 is for securing the envelope 13 in a fixture or a socket and for providing electrical current from the socket or fixture to the LED light bulb. A plurality of LEDs 25 are mounted on the inside surface 15 of the envelope 13 and disposed to emit light inwardly. One or more electrical elements 27 provide current to/from the plurality of LEDS 25.

Additional features, advantages, and embodiments of the invention may be set forth or apparent from consideration of the following detailed description. Moreover, it is to be understood that both the foregoing summary of the invention and the following detailed description are exemplary and intended to provide further explanation without limiting the scope of the invention.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a schematic view showing an embodiment of the present invention; and

FIG. 2 is a schematic view showing an embodiment of the present invention

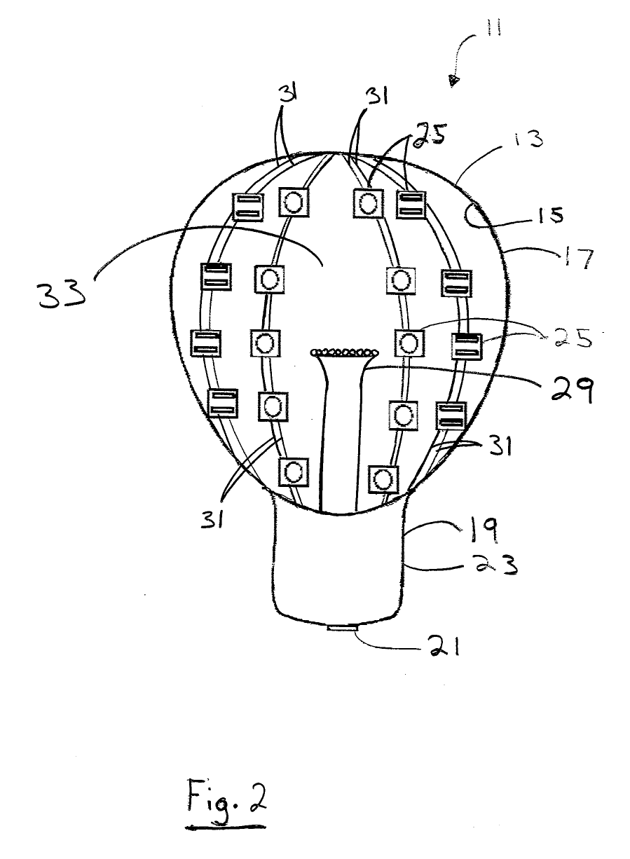

### DETAILED DESCRIPTION OF THE EMBODIMENTS

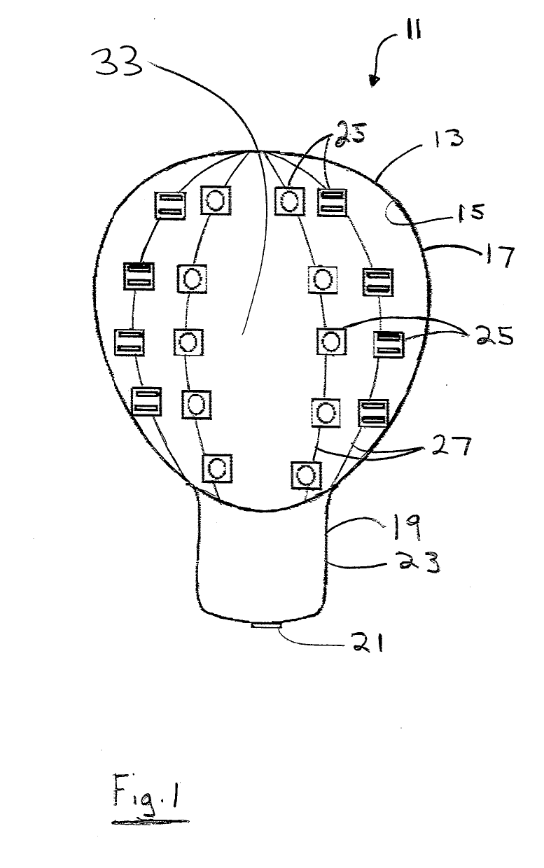

Turning to the drawings show at FIG. 1, the invention includes a distributed element LED light bulb 11 comprising an envelope 13 having an inside surface 15 and an outside surface 17. The light bulb 11 includes at least one mount 19 having a first conductive member 21 and a second conductive member 23. The mount 19 is for securing the envelope 13 in a fixture or a socket and for providing electrical current from the socket or fixture to the LED light bulb. A plurality of LEDs 25 are mounted on the inside surface 15 of the envelope 13 and disposed to emit light inwardly. One or more electrical elements 27 provide current to/from the plurality of LEDs 25.

The light bulb 11, in an alternate embodiment, further includes an incandescent filament contained within the envelope 13, operatively connected with the first conductive member 21 and/or the second conductive member 23 for providing incandescent light from the bulb 11. The object of including an incandescent filament in the LED bulb 11 is to provide the aesthetic feel or view of a traditional incandescent light bulb. Also the filament can be utilized to provide more red tones to the light output of the bulb, thereby providing a warmer light Lastly the filament may be used to provide much lower dimming levels as compared to common electronic ballast bulb, which normally can't dim to very low levels.

In a preferred embodiment, the plurality of LEDs 25 are mounted to the inside surface 15 of the light bulb 11 with a thermally conductive material effective to allow heat to flow from the LED to the envelope. Such would include any epoxy, polymer, or know material that has sufficient heat conductive properties. The plurality of LEDs 25 are mounted to enable conductive heat transfer from the LED 25 to the envelope 13. Examples include, embedding the LED in a droplet of thermally conductive material that is in contact with the envelope 13 or forms part of the envelope 13; bonding the LED 25 to the envelope with a thermally conductive material.

In an alternate embodiment, the plurality of LED 25 is mounted to thermally conductive rails 31. The thermally conductive rails 31 are thermally coupled with the LEDs 25 and the envelope 13, sufficient for the conduction of heat from a mounted LED 25 to the thermally conductive rails 31 to the envelope 13. In a preferred embodiment, the thermally conductive rails 31 are also electrically conductive for passing a current to/or and from the plurality of LEDs 25.

In an embodiment, the plurality of LEDs 25 and/or the thermally conductive rails 31 are formed into the envelope 13, or at least partially embedded into the envelope 13. This may be achieved by manufacturing process such as etching or channels made or formed into the envelope, but not limited to the same. In addition, the one or more electrically conductive elements 27 may be formed into the envelope 13, or at least partially embedded into the envelope 13. To allow for conduction of the heat.

In an embodiment of the present invention, the one or more electrical elements 27 are deposited on to the inside surface 15 of the envelope 13. This may be by any type of deposition process or etching known in the art.

As discussed herein, the envelope 13 can be made of any suitable material such as glass, or another material capable of transmitting the light, and conducting heat. Any material known in the art sufficient to achieve the desired results is envisioned as an embodiment of the present invention.

At least one mount 19 may be a mount for a screw in light bulb, a plug in mount such as those for automobiles, and may be for a florescent light bulb. The present invention may be employed to replace the conventional light bulbs known, including those discussed herein.

In a preferred embodiment of the present invention, the envelope 13 has a coating that diffusely reflects the light emitted from the LEDs 25. The coating should be sufficient to obscure individual sources of light emitting from the LEDs 25—more specifically, such that the individual LEDs 25 are not readily perceived by viewing the light bulb from a distance of 3 to 5 ft., for example. The material forming the envelope 13 may be engineered in such a way such that light is diffused to accomplish the same result. In addition, the material forming the envelope 13 may be comprised of a component that partly or fully masks or diffuses the light emitted from the LEDs 25.

Similarly, the envelope 13 may be comprised of photoluminescent component and/or a color-filtering component. Such that the color of the light emitted from the LEDs 25 is augmented, altered in some form, or filtered as the light travels through the envelope 13. The envelope 13 itself may achieve this result by its material engineering. Additionally, a layer of material may be applied to the envelope 13 to achieve the same desired result.

My invention includes a method of dissipating heat created by the operation of LEDs 25 inside a light bulb 11. The method includes providing an envelope 13 having an inside surface 15 enveloping a voidspace 33 and a outside surface 17. A plurality of LEDs 25 is provided. The LEDs 25 are mounted to the inside surface 15 such that the plurality of LEDs 25 emit light first through the void space 33 before passing through the envelope 13. The LEDs 25 when in operation generate light and heat. At least some of the heat is then conducted to the envelope 13.

The step of mounting the plurality of LEDs 25 further includes mounting LEDs 25 at a mounting site located in or on the envelope 13. The step of conducting the heat includes conducting the heat through the mounting site 35. It is envisioned that some structure will exist as the mounting site 35 and may include a thermally conductive epoxy, polymer metal, or other material existing between the envelope 13 and LED's 25 heat source.

My invention further includes a method of producing light using LEDs 25. An envelope 13 is provided. The envelope 13 has an inside surface 15 enveloping a voidspace 33 and an outside surface 17. A plurality of LEDs 25 are mounted on the inside surface 17 of the envelope 13. Alternately, the plurality of LEDs 25 is mounted with in the envelope 13 structure such that the light emitted from the plurality of LEDs 25 must first pass through the voidspace 33 before passing through the envelope 13. The envelope 13 is then screwed into a light bulb socket if the envelope 13 is designed to work with conventional screw in light fixtures. If the envelope 13 is designed to work in florescent type fixtures, the envelope 13 is mounted to a florescent bulb mount. In other embodiments, were the envelope 13 is of a plug in design, the envelope 13 is plugged into a retaining socket sufficient to allow current to flow to power the LEDs 25. The LEDs 25 are energized to emit light as discussed herein.

My method further includes the step of diffusing and/or scattering and/or filtering the light emitted from the plurality of LEDs 25 before or while the light passes through the envelope 13. The diffusing and/or scattering and/or filtering the light is optimized using known compositions or methods or structures in the art in order to optimize the color/and or harshness/and or other aesthetics of the light produced by the bulb 11.

In an embodiment of the method, the step of providing an envelope 13 includes providing two hemispherical sub-envelopes that are joined to form the envelope 13 this method provides one embodiment of producing my invention. In an alternate embodiment, two or more cooperating sub-envelopes are provided and joined to form the envelope 13 of the invented light bulb 11.

Although particular embodiments of the invention have been described in detail herein with reference to the accompanying drawings, it is to be understood that the invention is not limited to those particular embodiments, and that various changes and modifications, including the omission of steps or the interchangeability of the order of steps, may be effected therein by one skilled in the art without departing from the scope or spirit of the invention.

What is claimed:

1. A distributed element light-emitting-diode (LED) light bulb, comprising:
an envelope having an inside surface and an outside surface,
at least one mount having a first conductive member and a second conductive member, the mount for securing the envelope in a fixture or a socket and for providing electrical current from the socket or fixture to the LED light bulb,
a plurality of LEDs mounted on the inside surface of the envelope and disposed to emit light inwardly, and
one or more electrical elements sufficient to provide current to/from the plurality of LEDs.

2. The light bulb of claim 1, further including an incandescent filament contained within the envelope, operatively connected with the first conductive member and/or the second conductive member for providing incandescent light from the bulb.

3. The light bulb of claim 1, the plurality of LEDs mounted with a thermally conductive material effective to allow heat to flow from the LED to the envelope.

4. The light bulb of claim 1, the plurality of LED's mounted to enable conductive heat transfer from the LED to the envelope.

5. The light bulb of claim 1, the plurality of LED's mounted on thermally conductive rails and the thermally conductive rails thermally coupled with the LEDs and the envelope so to allow for the conduction of heat from a mounted LED to the thermally conductive rails to the envelope.

6. The light bulb of claim 5, the thermally conductive rails also being electrically conductive for passing current to and/or from the plurality of LEDs.

7. The light bulb of claim 5, the plurality of LEDs and/or the thermally conductive rails formed into the envelope, or at least partially embedded into the envelope.

8. The light bulb of claim 6, the plurality of LEDs and/or the thermally conductive rails formed into the envelope, or at least partially embedded into the envelope.

9. The light bulb of claim 1, the plurality of LEDs and/or the one or more electrically conductive elements formed into the envelope, or at least partially embedded into the envelope.

10. The light bulb of claim 1, the one or more electrical elements deposited onto the inside surface of the envelope.

11. The light bulb of claim 1, the envelope made of glass, or another material capable of transmitting light.

12. The light bulb of claim 1, the at least one mount selected from the group of a screw in mount, a plug in mount, and a fluorescent bulb mount.

13. The light bulb of claim 11, the envelope having a coating that diffusely reflects the light emitted from the LEDs sufficient to obscure individual sources of light emitting from the LEDs, such that the light bulb is perceived as a single point of light.

14. The light bulb of claim 11, the envelope diffusing, or comprised of a component that partly or fully masks or diffuses, the light emitted from the LEDs.

15. The light bulb of claim 11, the envelope comprised of, or having a layer of, a photoluminescent component and/or a color filtering component.

16. A method of dissipating heat created by the operation of LEDs inside a light bulb, comprising:
providing an envelope having an inside surface enveloping a voidspace and an outside surface,
providing a plurality of LEDs,
mounting the plurality of LEDs to the inside surface such that the plurality of LEDs emit light first through the voidspace before passing through the envelope,
generating light and heat with the plurality of LEDs, and
conducting at least some of the heat generated by the plurality of LEDs to the envelope.

17. The method of claim 16, wherein the step of “mounting the plurality of LEDs” includes mounting the LED's at a mounting site located in or on the envelope, and the step of “conducting the heat” includes conducting the heat through the mounting site.

18. A method of producing light using LEDs, comprising:
providing an envelope having an inside surface enveloping a voidspace and an outside surface,
mounting a plurality of LEDs on the inside surface of the envelope or in the envelope such that the light emitted from the plurality of LEDs must first pass through the voidspace before passing through the envelope,
screwing the envelope into a light bulb socket, or fixing the envelope to a fluorescent bulb mount, or plugging the envelope into a retaining socket, and
energizing the plurality of LEDs.

19. The method of claim 18, further comprising the step of diffusing and/or scattering and/or filtering the light, and/or changing the wavelength of the light through use of phosphorous material emitted from the plurality of LEDs before or while the light passes through the envelope.

20. The method of claim 18, the step of “providing an envelope” including providing two hemispherical, or two or more cooperating, sub-envelopes, and the method including the step of joining the two hemispherical, or two or more cooperating sub-envelopes.
